(19) United States
(12) Patent Application Publication
(10) Pub. No.: US 2011/0194306 A1
(43) Pub. Date: Aug. 11, 2011

(54) LIGHT EMITTING DEVICE

(75) Inventors: Marcellinus P. C. M. Krijn, Eindhoven (NL); Gabriel-Eugen Onac, Veldhoven (NL)

(73) Assignee: KONINKLIJKE PHILIPS ELECTRONICS N.V., EINDHOVEN (NL)

(21) Appl. No.: 13/125,979

(22) PCT Filed: Oct. 26, 2009
(86) PCT No.: PCT/IB09/54720

§ 371 Date: Apr. 26, 2011

(30) Foreign Application Priority Data
Nov. 5, 2008 (EP) 08168388.0

(51) Int. Cl. F21V 7/22

(52) U.S. Cl. 362/607

(57) ABSTRACT

The invention relates to a light-emitting device (1) comprising: a light source (2) for emitting light of a first wavelength range; a light guide (3) having a light receiving surface (4) for receiving at least part of said light emitted by the light source (2), a front surface (31) and a rear surface (32), for guiding light of said first wavelength range by total internal reflection at said front surface and said rear surface; a plurality of outcoupling elements (5) for outcoupling light from the light guide such that at least part of the light that is outcoupled by the outcoupling elements exits the light guide through said rear surface; a reflective member (6) arranged in rear of said light guide to reflect light that is outcoupled from the light guide; and a wavelength converting member (8) comprising a wavelength converting material arranged outside the light guide to convert light of said first wavelength range to light of a second wavelength range. Advantageously, in the light-emitting device according to the invention, the color, color temperature and/or color rendering index may be tuned by modifying the wavelength converting member. As a result, white light which is perceived as warm may be obtained.

### FIELD OF THE INVENTION

The present invention relates to a light-emitting device comprising a light source for emitting light of at least a first wavelength range; a light guide; a plurality of outcoupling elements for outcoupling light from the light guide; a reflective member arranged to reflect light that is outcoupled from the light guide; and a wavelength converting member comprising a wavelength converting material.

### BACKGROUND OF THE INVENTION

Light-emitting diode (LED) based lighting devices are increasingly used for a wide variety of lighting applications. LEDs offer advantages over traditional light sources such as incandescent and fluorescent lamps, including long lifetime, high lumen efficacy, low operating voltage, high purity of spectral colors and fast modulation of lumen output. However, one issue with LED lighting is the provision of “warm” white light. LEDs with high lumen efficacy (˜75 1 m/watt) available today produce light with a high color temperature (˜6000 K) and are thus perceived as “cold” white. For most general illumination applications a color temperature of 3000 K or less is preferred. In addition, the light should have a good color rendering index.

Low color temperature with a good color rendering index can be accomplished by means of phosphor in combination with illumination of a LED. Conventionally, the phosphor is embedded in glue that is directly attached to the LED chip. However, in such a solution the phosphor is exposed to the heat generated by the LED and to the light flux at the same time. As a result, very often this type of LED and phosphor solution does not meet the lifetime requirements necessary.

US 2007/0086184 A1 discloses an illumination system that includes one or more light sources that produce primary light, a light-mixing zone that homogenizes the primary light, a wavelength converting layer that converts the primary light to a secondary light, and a light-transmitting zone that receives the secondary light and transmits the secondary light. However, the wavelength converting layer of this system risks being overheated due to the generation of heat by the wavelength conversion event, resulting in reduced wavelength conversion efficiency (a phenomenon known as thermal quenching). Thus, there exists a need in the art for improved light-emitting devices.

### SUMMARY OF THE INVENTION

It is an object of the present invention to provide an improved light-emitting device. A particular object is to provide a light-emitting device that is particularly suitable for use in a LED based lighting arrangement, which is efficient and which allows for efficiency and tuning of the color, color temperature and/or color rendering index (CRI) of the emitted light.

In one aspect, the invention relates to a light-emitting device comprising:

a light source for emitting light of a first wavelength range;

a light guide having a light receiving surface for receiving at least part of said light emitted by the light source, a front surface and a rear surface, for guiding light of said first wavelength range by total internal reflection at said front surface and said rear surface;

a plurality of outcoupling elements for outcoupling light from the light guide such that at least part of the light that is outcoupled by the outcoupling elements exits the light guide through said rear surface;

a reflective member arranged in rear of said light guide to reflect light that is outcoupled from the light guide; and

a wavelength converting member comprising a wavelength converting material arranged outside the light guide to convert light of said first wavelength range to light of a second wavelength range.

The light-emitting device according to the invention benefits from the advantages of having the wavelength converting material arranged at a distance from the light source; for example, when using a plurality of LEDs for a light source, the light from several LEDs may be mixed before reaching the wavelength converting material, so that differences in emission characteristics between individual LEDs are averaged out, leading to no visible artifacts. Futhermore, the light-emitting device according to the invention has high lumen efficacy, since there is little chance a ray of light will be lost by being backscattered towards the LED die, and it also enables high light recycling efficiency, since wavelength converted light emitted in the “wrong” direction may be reflected in the direction of an observer.

Furthermore, arranging the wavelength converting material outside the light guide allows efficient cooling of the wavelength converting material, thus avoiding thermal quenching of the wavelength converting material.

Advantageously, in the light-emitting device according to the invention, the color, color temperature and/or CRI may be tuned by modifying the wavelength converting member (e.g. relative coverage of wavelength converting material). As a result, “warm” or “cold” white light may be obtained as desired. In most general lighting applications, a “warm” white light (that is, white light having a low color temperature) is desirable. Furthermore, by adapting the coverage of the outcoupling elements, a desired distribution of light from the light guide may be obtained.

In order to further improve the light recycling efficiency and mixing and/or distribution of light, the reflective member of the light-emitting device may be diffusive.

The wavelength converting member and the reflective member may be provided on different sides of the light guide, so as to provide good mixing and distribution of light. For example, the wavelength converting member may be provided in front of the light guide. Alternatively, the wavelength converting material may be arranged in the path of light from the light guide to the reflective member, typically between the light guide and the reflective member. In embodiments of the invention the wavelength converting material may be arranged on the reflective member; thus, the wavelength converting material can be efficiently cooled using a heat sink arranged in thermal contact with the wavelength converting material via the reflective member without the heat sink blocking the path of light to an observer. For example, a heat sink may be arranged on the rear side of the reflective member. Also, arranging the wavelength converting material on the reflective member saves space, and avoids any unwanted Fresnel reflections caused by a transparent substrate for supporting a wavelength converting material through which light is to be transmitted.

Furthermore, the wavelength converting member may comprise a plurality of discrete domains comprising wavelength converting material. Advantageously, the relative coverage (%) by the wavelength converting material may then be easily adapted during production by adapting the density of the domains and/or their size(s). Thus, a desired color and/or color temperature and/or color rendering index may be obtained. Also, domains comprising different types of wavelength converting materials may be easily produced.

Alternatively or additionally to said discrete domains comprising wavelength converting material, said wavelength converting member may comprise a continuous layer comprising a wavelength converting material. A continuous layer may provide improved uniformity of coverage of the wavelength converting material.

Furthermore, said plurality of outcoupling elements may be provided on an outer surface of the light guide. Typically, the outcoupling elements may be provided on said front surface of the light guide, or, alternatively, on said rear surface of the light guide. The outcoupling elements may comprise a scattering material. Using a scattering material for the outcoupling elements is cheap and, since no structural elements have to be produced in the light guide, production of the light guide is simplified.

In embodiments of the invention, the relative coverage of the front surface by the outcoupling elements may increase with the distance from the light receiving surface along the light guide. Hence, the outcoupling of light of uniform intensity all over the length of the light guide may be achieved.

Typically, the light source of the light-emitting device according to the invention comprises at least one light-emitting diode (LED).

In another aspect, the invention relates to the light guide as such of any embodiment of the light-emitting device described herein.

### BRIEF DESCRIPTION OF THE DRAWINGS

These and other aspects of the present invention will now be described in more detail, with reference to the appended drawings showing currently preferred embodiments of the invention, in which:

FIG. 1 shows a schematic cross-sectional view of a light emitting device according to an embodiment of the invention.

FIG. 2 shows a schematic cross-sectional view of selected parts of a light emitting device according to another embodiment of the invention.

FIG. 3 shows a schematic cross-sectional view of selected parts of a light emitting device according to yet another embodiment of the invention.

FIG. 4 is a perspective view of a light guide according to an embodiment of the invention as shown in FIG. 1.

FIG. 5 is a graph showing the color coordinates as measured for wavelength converting bodies according to various embodiments of the invention and a black body radiation curve.

### DETAILED DESCRIPTION OF THE INVENTION

As illustrated in the Figures, the sizes of layers and domains are exaggerated for illustrative purposes and, thus, are provided to illustrate the general structures of embodiments of the present invention.

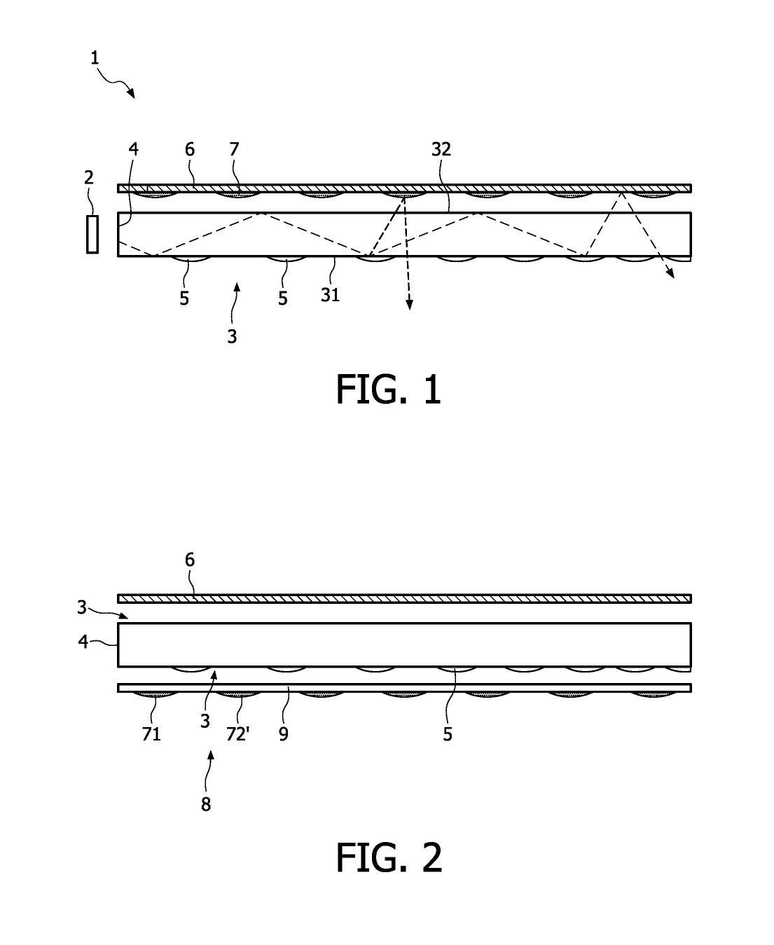

FIG. 1 shows a light-emitting device according to a currently preferred embodiment of the invention. The light-emitting device 1 comprises a light source 2 which is adapted to emit light of at least a first wavelength range. The light emitted by the light source is typically visible to near UV light. This first wavelength range is typically from 380 to 520 nm, preferably from 440 to 480 nm and more preferably from 450 to 470 nm. The light source may comprise at least one LED. LEDs having emission wavelength ranges as described above, as well as LEDs having other emission wavelengths, are known to persons skilled in the art.

Optionally, the light source may comprise a plurality of LEDs having different emission characteristics. For example, of a plurality of LEDs, at least one LED may emit light predominantly at 470 nm, whereas at least one other LED may emit light predominantly at 450 nm. By adapting the relative emission of different wavelengths from the light source, the color temperature of the light emitted by the light-emitting device may be tuned. As a result, “warm” or “cold” white light may be obtained as desired.

Light of said first wavelength range emitted by the light source 2, and optionally light of other wavelength ranges also emitted by the light source 2, may be coupled into a light guide 3 via a light receiving surface 4 of the light guide 3. Typically, the light source 2 is arranged adjacent to the light guide 3 and, in operation, emitting light generally in the direction of the light receiving surface 4. However, the light source may also emit light in other directions, in which case the light may be redirected by a reflective material before reaching the light receiving surface 4. In embodiments of the invention, the light guide 3 may comprise a plurality of light receiving surfaces, each light receiving surface 4 receiving light emitted by at least one light source 2. For example, each light receiving surface 4 may receive light emitted by a separate LED. Alternatively, a plurality of light receiving surfaces may receive light emitted by the same light source, e.g. the same LED.

The light guide 3 moreover has a front surface 31 and a rear surface 32. Having been coupled into the light guide 3, light of said first wavelength range is propagated by total internal reflection at at least the front surface 31 and the rear surface 32. The light guide 3 may be made of any material conventionally used for light guides.

As used herein, the term “light guide” refers to an optical element adapted to receive light emitted by a light source and in which at least part of said light is subject to total internal reflection at at least one surface of the light guide. Typically, light is subject to total internal reflection at at least two surfaces, such as a front surface and a rear surface. In the case of a cylindrical or tubular light guide, however, light may be subject to total internal reflection at a continuous envelope surface of the light guide.

In the embodiment shown in FIG. 1, the light guide 3 extends longitudinally from the light source 2, the light receiving surface 4 of the light guide 3 facing the light source 2. The light-emitting device 1 may comprise two or more light guides extending in different directions. The light guide may have any suitable shape, for example the shape of a rod, a plate, a disc or part of a disc. In embodiments of the invention, the light guide 3 may have a disc-like shape and may at least partially encircle the light source in a plane, the light receiving surface 4 forming an inner surface facing the light source 2. In embodiments of the invention, the light guide 3 may have the shape of a plate and may comprise at least one cavity or hole, in which the light source is arranged, said cavity or hole thus forming an optical chamber and also defining a light receiving surface of the light guide. Such a cavity or hole may for example have the shape of a diamond. Each such diamond-shaped cavity or hole typically defines at least two light receiving surfaces through which light from a single light source, e.g. an LED, may be coupled into the light guide. In yet other embodiments of the invention, the light guide 3 may comprise a plurality of cavities or holes, optionally arranged in at least one array, a light source such as an LED being arranged in each cavity or hole and emitting light which is coupled into the light guide via each light receiving surface. For example, a very thin plate-shaped light guide may comprise two arrays of said cavities or holes, located along the respective long sides of the plate-shaped light guide, a light source being arranged in each cavity or hole. A light-emitting device comprising a guide comprising holes or cavities as described above in which LEDs are arranged may be suitable for use in backlight applications.

Furthermore, the front surface 31 of the light guide 3 of FIG. 1 extends in the longitudinal direction of the light guide 3 and faces an observer of the light emitted by the light-emitting device 1. The rear surface 32 also extends in the longitudinal direction of the light guide and is located on the side of the light guide 3 opposite from an observer of the light emitted by the device 1. The front surface 31 and the rear surface 32 form interfaces with a medium or material outside the light guide. The medium or material outside the light guide 3 may be air, or it may be a liquid or solid material. For example, the light guide may be at least partly embedded in a transparent material having an index of refraction that is less than the index of refraction of the light guide. Such a material may form a cladding layer functioning e.g. as a scratch resistant layer. Furthermore, for the purpose of mechanical support, the light guide may be in contact with a solid material. In case the index of refraction of a mechanical support material is higher than the index of refraction of the light guide, the contact area of the light guide with said material should be small in order not to result in extensive outcoupling of light by the mechanical support material, which is generally undesired.

Light outcoupling elements 5 are provided on the light guide 3 for outcoupling light therefrom. The outcoupling elements are adapted to reflect and/or scatter at least part the incident light at an angle which does not result in total internal reflection when the reflected and/or scattered light subsequently meets the rear surface 32. Hence, at least part of the light reflected by an outcoupling element 5 exits the light guide 3 via the rear surface 32. Another part of the light reflected or scattered by an outcoupling element 5 may be so at an angle which results in total internal reflection at the rear surface 32.

Thus, having been reflected and/or scattered by an outcoupling element, a ray of light may exit the light guide upon its very next incidence on an interface between the light guide and a medium, such as air, outside the light guide. However, part of the light incident on an outcoupling element will be reflected at an angle which results in continued total internal reflection within the light guide 3. Typically, the outcoupling elements 5 achieve outcoupling of light of said first wavelength range from the light guide 3.

The light outcoupling elements 5 of the embodiment shown in FIG. 1 are provided on the front surface 31 of the light guide 3. The light outcoupling elements may be structural elements of the light guide, for example surface deformations such as indentations, wedges or apices, and/or may comprise a scattering material disposed on a surface of the light guide. In the embodiments of the invention shown in FIGS. 1-3, the light outcoupling elements are formed of discrete domains, or dots, of diffusive reflective material arranged on a surface of the light guide. Such dots of diffusive reflective material may be provided using e.g. printing techniques. Examples of suitable materials include titanium dioxide. Suitable diffusive reflective materials are known to persons skilled in the art.

In embodiments of the invention, the light outcoupling elements transmit little or no light of said first wavelength range. Since light of the first wavelength range (e.g. blue light) that is transmitted might not be received by a wavelength converting material for conversion to the second wavelength range (e.g. yellow light), the performance of the white light-emitting device may be affected by the amount of light of said first wavelength range that is lost by being transmitted by the outcoupling elements. Typically, the light outcoupling elements may transmit 30% or less of the incident light of said first wavelength range. In order to further improve the efficacy of the light-emitting device, 20% or less, for example 10% or less, of the incident light of the first wavelength range may be transmitted by the outcoupling elements.

The distribution of light outcoupling elements 5 may be adapted to obtain the desired distribution of light emitted from the light-emitting device. For example, the relative coverage of the outcoupling elements may increase along the length of the light guide, so that the outcoupling elements are more densely arranged in a region of the light guide 3 far away from the light receiving surface 4 than in a region of the light guide 3 close to the light receiving surface 4. Such a distribution of the outcoupling elements enables outcoupling of light of uniform intensity all over the length of the light guide. The light outcoupling elements 5 may be arranged in any suitable pattern to obtain a desired light outcoupling distribution from the light guide. A possible distribution of the outcoupling elements is illustrated in FIG. 4, which is a perspective view of a light guide 3 comprising a light receiving surface 4 and having a plurality of outcoupling elements 5 arranged on the front surface 31.

Furthermore, a reflective member 6 is arranged to reflect light that has been outcoupled through the rear surface 32 back towards the light guide 3, through which the reflected light may then be transmitted without being subject to total internal reflection. The reflective member 6 is typically provided in rear of the light guide 3. The reflective member may be a diffuse reflective plate or layer made of any conventional reflective material used in the art, for example a metal or a reflective polymer such as MCPET.

Furthermore, a plurality of domains 7 comprising a wavelength converting material 7 are arranged on the reflective member 6. Thus, the reflective member 6 is a combined reflective and wavelength converting member. The wavelength converting material is adapted to convert light of a first wavelength range to light of a second wavelength range, i.e., to absorb light of said first wavelength range and emit light of said second wavelength range. Thus, light that is outcoupled from the light guide 3 by the light outcoupling elements 5 provided on the front surface 31 of the light guide 3 may exit the light guide 3 through the rear surface 32 and may then either be directly reflected back towards the light guide by the reflective member 6, or, when incident on a domain 7 comprising wavelength converting material, be converted and/or scattered by the wavelength converting material. A part of the light that is emitted or scattered by the wavelength converting material may also be reflected towards the light guide 3 by the reflective member 6. Light of said first wavelength that is reflected and/or scattered by the reflective member 6 and/or the wavelength converting material, and light of said second wavelength emitted by the wavelength converting material, may be transmitted through the light guide 3 to exit the light guide via the front surface 31. Thus the light emitting device 1 provides good mixing of unconverted and converted light.

Since light emitted by the wavelength converting material is scattered by the wavelength converting material, and also may be diffusively reflected by the reflective member 6, part of the converted light may be subject to total internal reflection after entering the light guide 3. However, a major part of the light that is subject to total internal reflection within the light guide 3 is light of said first wavelength range which has not (yet) been outcoupled from the light guide 3.

The wavelength converting material may be any suitable wavelength converting material, also known as a phosphor, known in the art. However, preferred wavelength converting materials may be selected from garnets and nitrides, especially doped with trivalent cerium or divalent europium, respectively. Embodiments of garnets especially include A₃B₅O₁₂ garnets, wherein A comprises at least yttrium (Y) or lutetium (Lu) and wherein B comprises at least aluminum (Al). Such garnet may be doped with cerium (Ce), with praseodymium (Pr) or a combination of cerium and praseodymium; especially however with Ce. Typically, B comprises aluminum; however, B may also partly comprise gallium (Ga) and/or scandium (Sc) and/or indium (In). In another variant, B and O may at least partly be replaced by Si and N. The element A may especially be selected from the group consisting of yttrium (Y), gadolinium (Gd), terbium (Tb) and lutetium (Lu). Typically, Gd and/or Tb are only present up to an amount of about 20% of A. In a specific embodiment, the wavelength converting material comprises (Y₁₋ₓLuₓ)₃B₅O₁₂:Ce, wherein x is equal to or larger than 0 and equal to or smaller than 1. The term “:Ce”, indicates that part of the metal ions (i.e. in the garnets: part of the “A” ions) in the wavelength converting material is replaced by Ce. For instance, assuming (Y₁₋ₓLuₓ)₃Al₅O₁₂:Ce, part of Y and/or Lu is replaced by Ce. This notation is known to the person skilled in the art. Ce will replace A in general for not more than 10%.

In other embodiments, the wavelength converting material may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation. The term “:Eu” indicates that part of the metal ions is replaced by Eu. Divalent europium will in general replace divalent cations, such as the above divalent alkaline earth cations, especially Ca, Sr or Ba.

The wavelength converting material is adapted to absorb light in said first wavelength range emitted by the light source, which is typically light in the range of from 380 to 520 nm, preferably from 440 to 480 nm and more preferably from 450 to 470 nm; however, if the light source emits light in a wavelength range other than 380-520 nm, the wavelength converting material may be adapted to absorb light of a wavelength range having at least one endpoint lower and/or higher than 380-520 nm. The wavelength converting material may emit light in the wavelength range of from 450 to 750 nm.

When the wavelength converting member comprises discrete domains comprising a wavelength converting material, the color temperature of the light emitted from the light-emitting device may be tuned by adapting the relative coverage of the wavelength converting material. For example, the relative coverage of domains comprising wavelength converting material at a concentration of 20% may be in the range of 40-80%.

It may desirable to use more than one wavelength converting material in order to provide conversion from and/or to a wider range of wavelengths than can be achieved using a single wavelength converting material. Therefore, in embodiments of the invention, the light-emitting device may comprise a second wavelength converting material. Typically, the wavelength converting member comprises discrete domains comprising said second wavelength converting material in addition to the domains comprising the first wavelength converting material described above.

The second wavelength converting material typically a) absorbs light of the same wavelength range as said first wavelength converting material and emits light of a wavelength range different from that emitted by the first wavelength converting material, or b) absorbs light of a wavelength range different from that absorbed by the first wavelength converting material and emits light of a wavelength range different from that emitted by the first wavelength converting material. However, it is also possible that the second wavelength converting material absorbs and emits light of substantially the same wavelength ranges as the first wavelength converting material.

In embodiments of the invention, both wavelength converting materials may absorb light of different subranges of said first wavelength range emitted by the light source.

Advantageously, by extending the wavelength range of the wavelength converted light, the color rendering index may be improved and/or, in the case of white light, the color temperature may be decreased.

The wavelength converting member may also comprise a further wavelength converting material adapted to absorb and emit light of desired wavelength ranges.

By using two or more types of wavelength converting materials, light emitted by the light source may be efficiently converted and the color and/or the color temperature and/or the color rendering index of the light emitted by the light-emitting device may be tuned by adapting the relative coverage and concentration of each wavelength converting material.

Furthermore, the wavelength converting body may be thermally connected to a heat sink for dissipation of heat generated by the wavelength converting material. For example, heat generated by the wavelength converting material may transferred along a heat transfer path extending from the wavelength converting material via the reflective member 6 to a heat sink arranged in thermal contact with the reflective member 6. Typically, the heat sink is arranged on a rear side of the reflective member 6. Thus, advantageously, heat may be efficiently transported away from the wavelength converting material, so that thermal quenching of the wavelength converting material is avoided, without the path of light being interrupted by a heat sink. The heat sink may be of any material conventionally used in the art for heat dissipation structures, for example a metal, e.g. aluminum or copper. For example, the heat sink may be a patterned heat conductive plate that is in contact with the reflective member or another substrate on the wavelength converting material is arranged, either directly via mechanical pressure, or via an adhesive material, The heat sink is typically not in optical contact with the light guide 3.

In another embodiment of the invention illustrated in FIG. 2, a wavelength converting member 8 is arranged in front of the light guide 3. The wavelength converting member 8 comprises domains 7 comprising wavelength converting material arranged on a translucent substrate 9 on a side of the substrate 9 facing the light guide 3. However, domains of wavelength converting material could alternatively or additionally be arranged on the side of the substrate 9 facing away from the light guide 3. In the embodiment of FIG. 2, light of said first wavelength that is outcoupled by the light outcoupling elements 5, which are provided on the front surface 31 of the light guide 3, exits the light guide 3 through the rear surface 32 and is subsequently reflected by the reflective member 6 back towards the light guide 3, through which the light reflected by the reflective member 6 may then be transmitted. The light transmitted through the light guide 3 may subsequently be converted by the wavelength converting material of the wavelength converting member 8 and sent in the direction of the observer or sent back in the direction of the reflective member 6. It may be desirable that the domains 7 comprising wavelength converting material are thick enough to transmit substantially no or only little light, so that wavelength converted light emitted by the wavelength converting material is reflected by the reflective member 8 before exiting the light-emitting device 1. Thus, good mixing of light may be obtained.

The wavelength converting member 8 may comprise a second wavelength converting material as described above. Furthermore, as shown in FIG. 2, when the wavelength converting member 8 comprises discrete domains comprising a wavelength converting material, at least one domain 71 may comprise a first wavelength converting material as described above, and at least one domain 72 may comprise a second wavelength converting material as described above. The domains 71 and 72 may be arranged in any desired pattern in order to obtain a desired distribution of converted light, for example for tuning the color and/or the color temperature of the light emitted by the light-emitting device.

In embodiments of the invention, as an alternative to or in addition to the discrete domains comprising a wavelength converting material, the wavelength converting member 8 may comprise a continuous layer comprising at least one wavelength converting material. Optionally, such a layer may also comprise a scattering material, for example titanium dioxide. In such embodiments, the color temperature of the light emitted by the light-emitting device may be tuned by adapting the concentration of wavelength converting material in the continuous layer, the thickness of the continuous layer and/or the wavelength converting material composition of the continuous layer.

For example, the wavelength converting member 8 may comprise a continuous layer comprising said first wavelength converting material and, arranged on said continuous layer, discrete domains comprising said second wavelength converting material. Alternatively, the continuous layer may comprise said second wavelength converting material and the discrete domains arranged thereon may comprise said first wavelength converting layer. Alternatively, a continuous layer may comprise both said first wavelength converting material and said second wavelength converting material. The coverage, concentration and pattern of the discrete domains and/or the continuous layer comprising wavelength converting material, respectively, may be as described above.

The wavelength converting body 8 may be thermally connected to a heat sink for the dissipation of heat generated by the wavelength converting material.

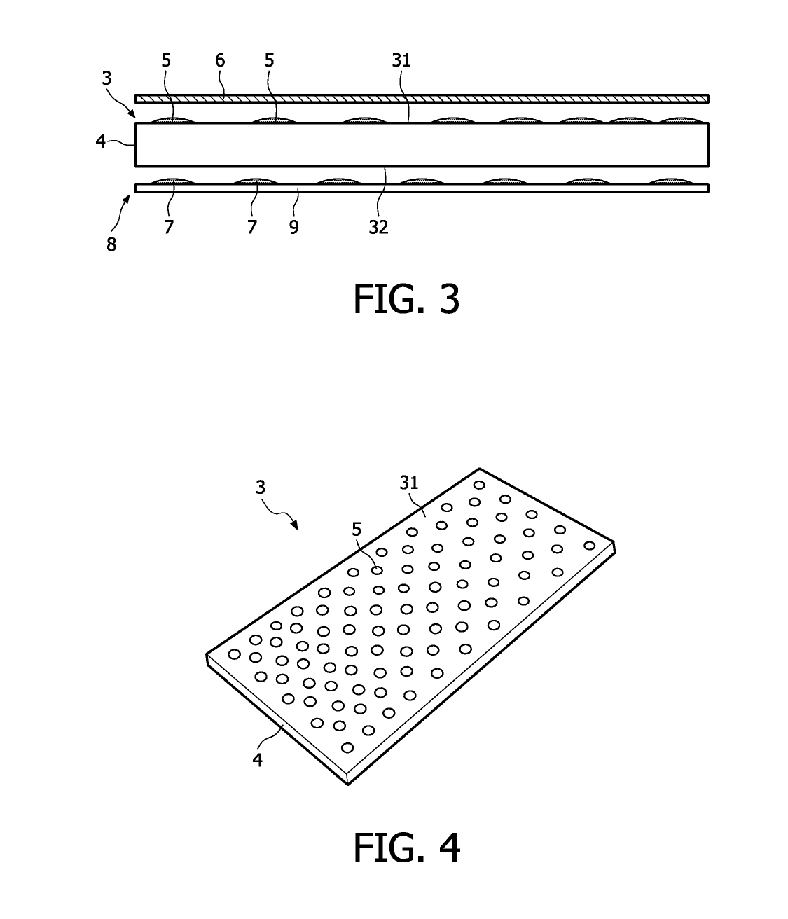

In a further embodiment of the invention illustrated in FIG. 3, outcoupling elements 5 are provided on a surface 31 of the light guide 3. A wavelength converting member 8 comprising a translucent substrate 9 and discrete domains comprising a wavelength converting material is provided outside the light guide 3. The domains 7 may be arranged on either side of the substrate 9. Thus, a part of the light of said first wavelength range that is outcoupled from the light guide 3 by the outcoupling elements 5 may be absorbed by the wavelength converting material of the wavelength converting member 8. Light of the first wavelength range that is not absorbed by the wavelength converting material may be transmitted through the translucent substrate. The part of the light that is absorbed by the wavelength converting material is converted into light of a different wavelength range, such as said second wavelength range. Since a wavelength converting material emits light in random directions, part of the wavelength converted light will be emitted in the direction of the observer (downwards in the Figure), and part of the wavelength converted light will be emitted in the direction of the light guide. Wavelength converted light emitted in the direction of the light guide 3 may be transmitted through the light guide 3 and subsequently be reflected back in the direction of the observer. Also light of the first wavelength range (i.e., non-converted light) that is scattered by the wavelength converting material back through the light guide may be reflected by the reflective member. By thus using a reflective member 6, the light output in the direction of the observer may be increased, and the mixing of non-converted and converted light may be further improved.

In a further embodiment of the invention the light source 2 comprises a plurality of LEDs. The LEDs may be adapted to emit light of said first wavelength range, and optionally they may emit light of different subranges of said first wavelength range. For example one LED may emit light predominantly at 470 nm, whereas another LED may emit light predominantly at 450 nm. By adapting the relative emission of different wavelengths from the light source, the color temperature of the light emitted by the light-emitting device may be tuned. Furthermore, since light from different LEDs may be mixed before entering the light guide 3 via the light receiving surface 4, the emission characteristics of an individual LED may have a less pronounced effect on the light reaching the wavelength converting member 8, compared to the case when only one LED is used in the light source 2. Alternatively, the plurality of LEDs may comprise at least one LED emitting light of said first wavelength and at least one LED emitting light of a wavelength range different from said first wavelength range. For example, in addition to one or more LED(s) emitting light in the blue light wavelength range, at least one LED emitting light in the green light wavelength range could be used. In embodiments in which the light source comprises LEDs emitting light of different wavelength ranges, typically first and second wavelength converting materials having different absorption and optionally also different emission wavelength ranges are used.

### EXAMPLE

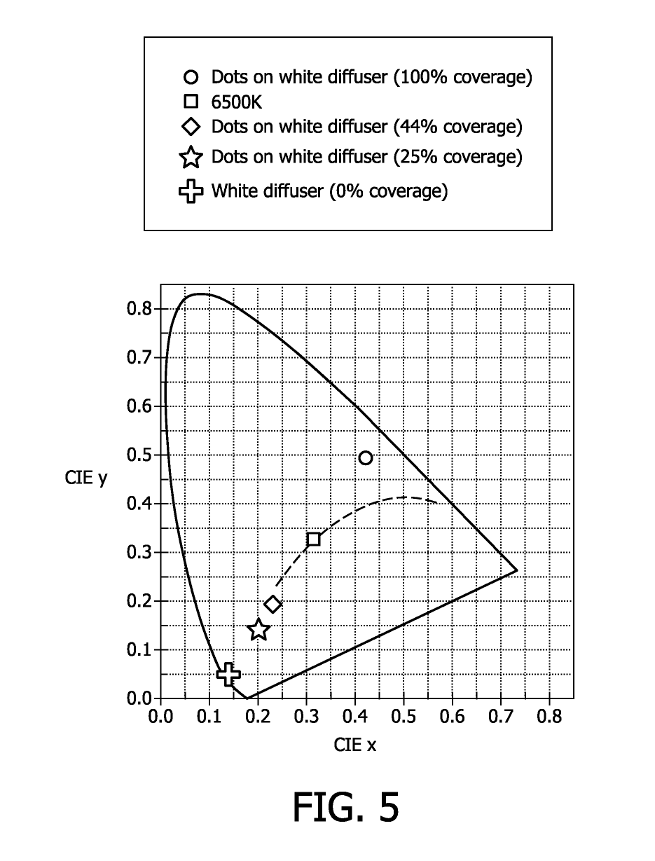

In order to test the wavelength conversion and reflection parts according to embodiments of the present invention, different sets of dots of a Ce-doped yttrium aluminum garnet (also referred to as Ce:YAG) phosphor material embedded in a transparent resin were deposited each onto a white diffuser (MCPET, Furukawa Electric). The dots were deposited in a fine regular rectangular pattern. The estimated concentration of Ce:YAG material in the dots was 20%. The sets of dots represented a phosphor coverage of 25%, 44% and 100%, respectively. The sets of dots, and the white diffuser without any phosphor dots (representing 0% phosphor coverage), were illuminated perpendicularly with light from LEDs emitting light of a wavelength of 460 nm. The resulting color varied from blue (0% coverage) to yellow (100% coverage). The color coordinates of the light emanating from the respective sets were measured. The results are presented in FIG. 5, in which the dashed line represents the black body curve. From this Figure it can be concluded that it is possible to find a phosphor coverage percentage that yields white light. For example, by interpolation it can be seen that a phosphor coverage of about 65% would yield white light with a color temperature of 6500 K. By altering the composition of the wavelength converting material, light of any desired color temperature could be obtained.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. Light-emitting device comprising:
a light source for emitting light of a first wavelength range;
a light guide having
a light receiving surface for receiving at least part of said light emitted by the light source,
a front surface and
a rear surface, for guiding light of said first wavelength range by total internal reflection at said front surface and said rear surface;
a plurality of outcoupling elements for outcoupling light from the light guide such that at least part of the light that is outcoupled by the outcoupling elements exits the light guide through said rear surface;
a reflective member arranged in rear of said light guide to reflect light that is outcoupled from the light guide; and
a wavelength converting member comprising a wavelength converting material arranged outside the light guide to convert light of said first wavelength range to light of a second wavelength range.

2. Light-emitting device according to claim 1, wherein said reflective member is diffusive.

3. Light-emitting device according to claim 1, wherein said wavelength converting member and said reflective member are provided on different sides of the light guide.

4. Light-emitting device according to claim 1, wherein said wavelength converting member is provided in front of the light guide.

5. Light-emitting device according to claim 1, wherein said wavelength converting material is arranged in the path of light from said light guide to said reflective member.

6. Light-emitting device according to claim 5, wherein said wavelength converting material is arranged on said reflective member.

7. Light-emitting device according to claim 1, wherein said wavelength converting member comprises a plurality of discrete domains comprising wavelength converting material.

8. Light-emitting device according to claim 5, wherein said wavelength converting member comprises a continuous layer comprising a wavelength converting material.

9. Light-emitting device according to claim 1, wherein said plurality of outcoupling elements is provided on an outer surface of the light guide.

10. Light-emitting device according to claim 1, wherein said plurality of outcoupling elements are provided on said front surface of the light guide.

11. Light-emitting device according to any one of the preceding claims, wherein said outcoupling elements comprise a scattering material.

12. Light-emitting device according to claim 1, wherein the coverage of said front surface by the outcoupling elements increases with the distance from the light receiving surface along the light guide.

13. Light-emitting device according to claim 1, wherein the light source (2) comprises at least one light-emitting diode.

14. Light guide, comprising a light receiving surface for receiving light, a front surface and a rear surface, for guiding light of a first wavelength range by total internal reflection at said front surface and said rear surface, and further comprising a plurality of outcoupling elements for outcoupling light from the light guide through said rear surface, wherein said light guide is as defined in claim 1.
